(19) United States
(12) Patent Application Publication
(10) Pub. No.: US 2004/0116839 A1
(43) Pub. Date: Jun. 17, 2004

(54) Gait training apparatus

(75) Inventor: Thompson Sarkodie-Gyan, Socorro, NM (US)

Correspondence Address: ROBERT W. BECKER & ASSOCIATES, Suite B, 707 Highway 66 East, Tijeras, NM, 87059, US

(73) Assignee: New Mexico Technical Research Foundation

(21) Appl. No.: 10/319,760

(22) Filed: Dec. 13, 2002

(51) Int. Cl. A61H 1/00; A61H 1/02; A61H 5/00

(52) U.S. Cl. 601/35; 601/33

(57) ABSTRACT

A gait training apparatus is provided, and includes a frame, and two robotic limb movement assemblies that are connected to the frame. Each of the limb movement assemblies is adapted to receive a leg of a patient, and comprises a plurality of sections, each of which is provided with devices to move that portion of a patient's leg that is received therein.

### BACKGROUND OF THE INVENTION

The present invention relates to a gait training apparatus for emulating a patient's normal or physiological gait cycle.

After an accident, disease or the like leaves a patient with a damaged or otherwise impaired leg, it is necessary to provide rehabilitation to restore mobility to the patient's leg. Although exercise rehabilitation equipment is, of course, known in a variety of embodiments, the heretofore known equipment relies heavily on a gait therapist to help deliver a desired training gait to a patient, for example while they walk on a treadmill. The patient is supported in a harness, while one or more therapists hold the patient's legs and move them through the desired motion. In addition to being highly labor intensive, such apparatus make it difficult to maintain repeatability and consistency in the gait motion, especially from one session to the next.

In an attempt to remedy the foregoing situation, gait trainers have been developed in which a patient's legs are positioned on footplates that move backward and forward, as well as vertically. Unfortunately, none of the known apparatus allow for emulation of a normal or physiological gate cycle, and at best allow for non-physiological movement.

It is therefore an object of the present invention to provide a gait training apparatus that allows for true emulation of a patient's normal or physiological gait cycle.

### SUMMARY OF THE INVENTION

The object of the present invention is realized by a gait training apparatus that comprises a frame, and two robotic limb movement assemblies that are connected to the frame, wherein each of the limb movement assemblies is adapted to receive a leg of a patient, and wherein each of the limb movement assemblies comprises a plurality of sections, each of which is provided with means to move that portion of the patient's leg that is received therein.

In conjunction with the inventive apparatus, after a patient's normal gait is analyzed, this data is used to control the robotic limb movement assemblies and hence the gait of the impaired leg.

Pursuant to further specific embodiments of the present invention, each limb movement assembly can comprise two or more sections, and in particular a thigh movement assembly and a calf movement assembly, as well as optionally a hip movement assembly. Each of the sections of the limb movement assemblies may be operatively connected and controlled in an interrelated manner.

The various sections of the limb movement assemblies can be provided with actuating means to effect movement of a portion of a patient's leg received therein. Such actuating means can be computer controlled linear actuators, which can be of a piston/cylinder type. Each of the sections of the limb movement assemblies can also be provided with an adjustable guide rod, such as a telescoping guide rod. Further specific features of the present invention will be described in detail subsequently.

### BRIEF DESCRIPTION OF THE DRAWINGS

The object and advantages of the present invention will appear more clearly from the following specification in conjunction with the accompanying schematic drawings, in which:

FIG. 1 is a pictorial illustration of a preferred embodiment of the unitary device for patient gait training of the present invention.

FIG. 2 is an exploded view of the lower limb movement means showing how the various parts are assembled.

FIG. 3 is a front section view along the section 3-3 of FIG. 1 showing the construction of the lower limb movement means of the present invention.

FIG. 3a is a detail section view of FIG. 3 showing the connection between height adjuster and the hip actuator assembly.

FIG. 3b is a detail section view of FIG. 3 showing the connection between the hip assembly and the upper leg movement assembly.

FIG. 3c is a detail section view of FIG. 3 showing the connection between the thigh assembly and the lower leg movement assembly.

FIG. 4 is an exploded view of the height adjuster assembly showing how the parts are assembled.

FIG. 5 is an exploded view of the hip assembly showing how the various parts are assembled.

FIG. 6 is an exploded view of the thigh assembly showing how the various parts are assembled.

FIG. 7 is an exploded view of the calf assembly showing how the various parts are assembled.

FIG. 8 is a pictorial illustration of a typical treadmill use of a preferred embodiment of the present invention, showing the device in use by a patient using a treadmill.

FIG. 9 is a side detail view showing the patient's leg attached to the lower limb movement means.

### DESCRIPTION OF PREFERRED EMBODIMENTS

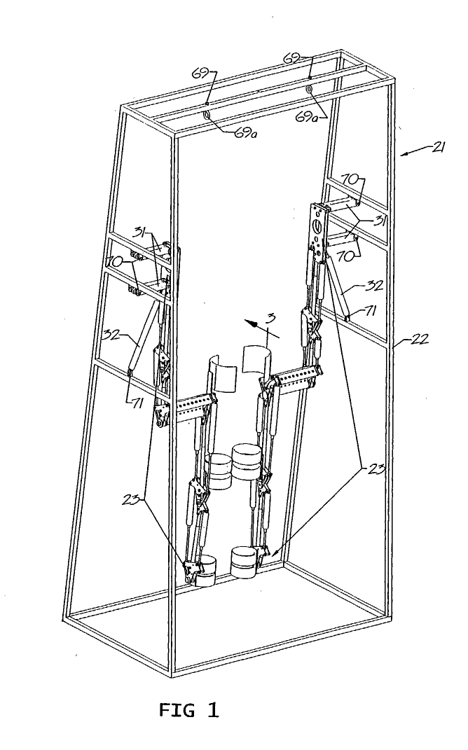

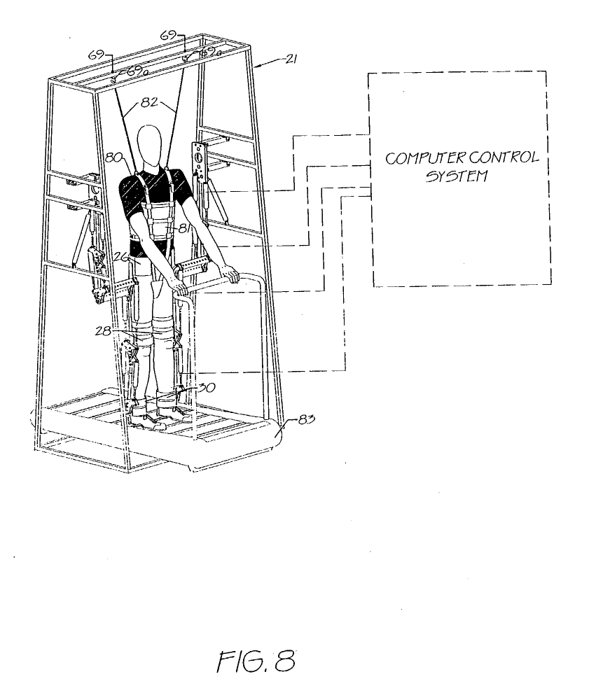

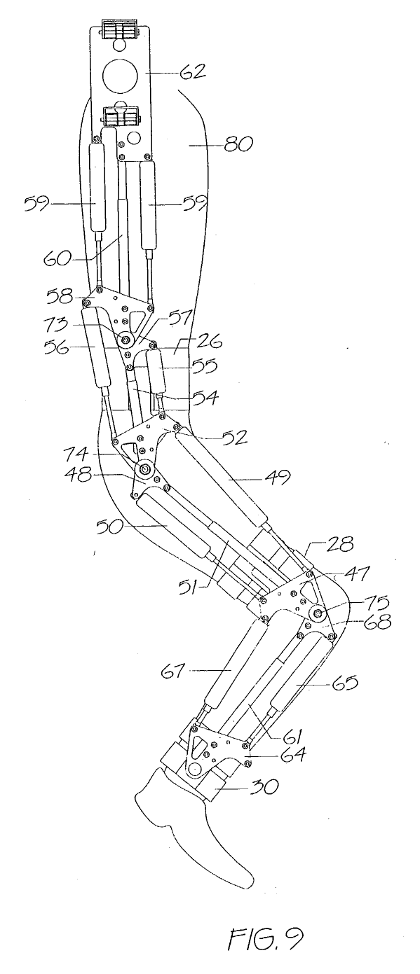

FIG. 1 shows a preferred embodiment of the unitary device 21 for gait training of the present invention. The unitary device 21 includes a support frame or means 22, and two powered lower limb movement means 23. The lower limb movement means 23 are secured to the support means 22 via bolts 70 that are attached to two swing-arm elements 31 and linear actuator 32. Provision for attachment of a patient harness to the support means 22 (in a well-known manner) is provided by eyebolts 69 and securing nut means 69a (see also FIG. 8).

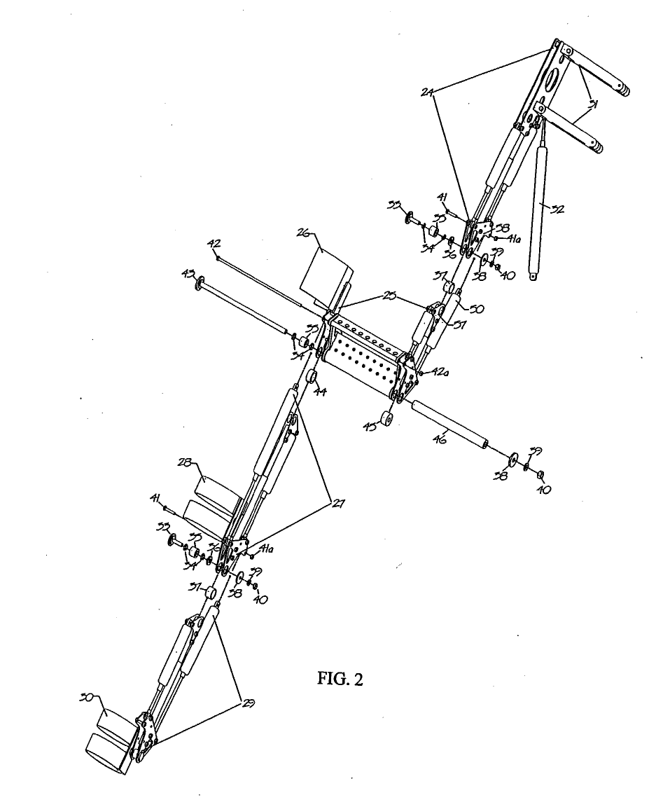

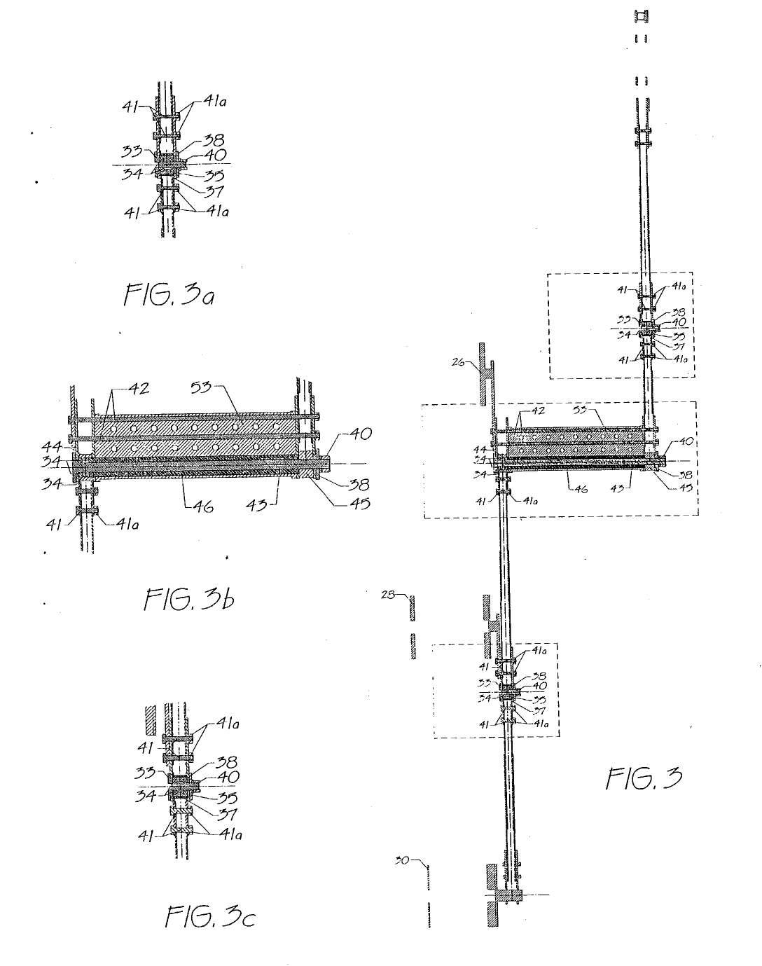

FIG. 2 is an exploded view showing the construction of one of the lower limb movement means 23. The lower limb movement means 23 is comprised of a height adjuster assembly 24, a hip movement assembly 25, a thigh movement assembly 27, and a calf movement assembly 29. The height adjuster assembly 24 is attached to the hip movement assembly 25 via a bearing mounted through holes in support plate elements 57 and 58. In addition, a bolt 41 and a nut 41a attach the linear actuator 56 to the support plate elements 58. The bearing comprises an axle 33, two anti-friction (ball) bearing elements 34, a bearing holder 35, spacers 36 and 37, an end plate 38, a lock washer 39, and an axle nut 40. Assembled bearing components are best seen in section as shown in FIGS. 3 and 3a. The hip movement assembly 25 is attached to the thigh movement assembly 27 via a bolt 42 protruding through the upper end of the linear actuator 49 and through the hip movement assembly 25. In addition, holes in the support plates 48 and various parts of the hip movement assembly are fitted with a bearing allowing rotation between the hip movement assembly 25 and the thigh movement assembly 27. The bearing is comprised of an axle 43, two anti-friction bearings 34, a bearing holder 35, spacers 44, 45, and 46, an end plate 38, a washer 39, and an axle nut 40. Assembled hip movement assembly 25 and thigh movement assembly 27 are best shown in FIG. 3b. In a similar manner, the thigh movement assembly 27 is attached to the calf movement assembly 29 via a bolt 41 inserted through the hole in the upper end of the linear actuator 67 and support plates 47. In addition, the thigh movement assembly 27 is attached to the calf movement assembly 29 via a bearing inserted in holes in the support plates 68 and 47. The bearing is comprised of an axle 33, two anti-friction (ball) bearing elements 34, a bearing holder 35, spacers 36 and 37, an end plate 38, a lock washer 39, and an axle nut 40. Bearing 75 is best shown assembled in FIG. 3c.

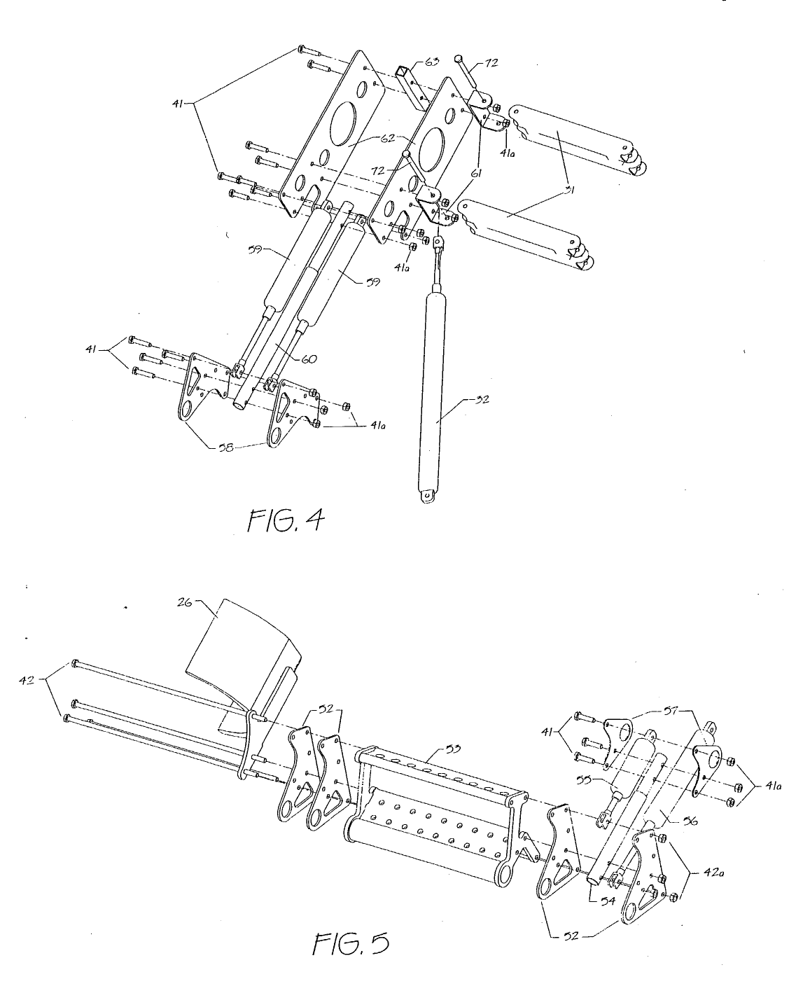

FIG. 4 is an exploded view showing the construction of the height adjuster assembly 24. As shown, on the lower end of the assembly, two linear actuators 59 and a guide rod 60 are constrained by support plate elements 58 in conjunction with threaded fasteners 41 and securing nuts 41a. On the upper end of the assembly, the linear actuator 59 and the guide rod 60 are constrained by support plate elements 62. A spacer element 63 serves to maintain appropriate distance between the support plate elements 62. Two brackets 61 are attached to the support plate elements 62 using threaded fasteners 41 and 41a. The swing-arm elements 31 are attached to the brackets 61 with bolts 72 in such a manner as to allow rotation of the swing-arm elements 31 about the bolts 72. Linear actuator 32 is attached to the lower bracket 61 using bolt 72. Preferably, the support plates 62 and brackets 61 are constructed of sheet metal, either steel or aluminum. The linear actuators 59 are of any commonly available commercial type (hydraulic, pneumatic, or electrical) suitable for the load and movement requirements of the height adjuster assembly 24.

FIG. 5 is an exploded view showing the assembly of the various components of the hip movement assembly 25. As shown, on the upper end of the assembly, a linear actuator 55 and a guide rod 54 are constrained by two support plate elements 57 and threaded fasteners 41 and securing nuts 41a. The attachment of the linear actuator 55 to the support plates 57 is in a manner that allows free rotation of the linear actuator about the fastener 41. On the lower end of the assembly, two sets of support plates 52 and spacer 53 along with threaded fasteners 42 and securing nuts 42a constrain the guide rod 54 and the linear actuators 55 and 56, as shown. The linear actuators 55 and 56 are attached in such a way as to allow free rotation about the fasteners 42. Preferably, the support plate elements 57 and 52 are made of sheet metal, either steel or aluminum. The guide rod 54 comprises two concentric tubing elements arranged to limit motion to that along their shared primary axis, for example in a telescoping manner.

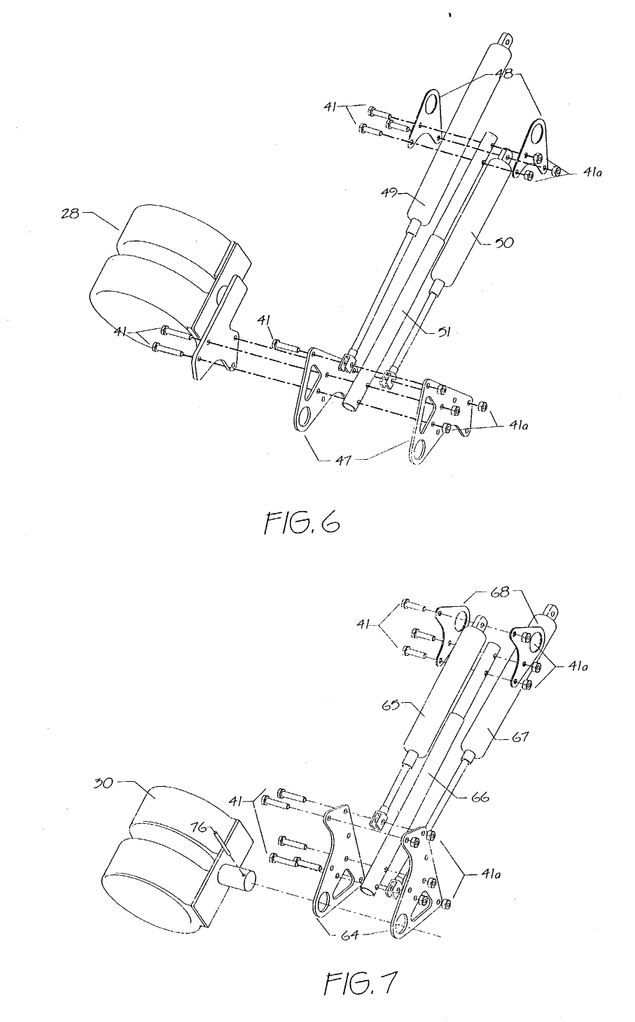

FIG. 6 is an exploded view showing the construction of the thigh or upper leg movement assembly 27. On the upper end of the assembly, a linear actuator 50 and guide rod 51 are held by support plates 48 and threaded fasteners 41 and 41a. On the lower end of the assembly, linear actuators 49 and 50 and the guide rod 51 are held by support plate elements 47 and threaded fasteners 41 and 41a. Upper leg holder 28 is attached to support plate elements 47 by way of threaded fasteners 41 and 41a.

FIG. 7 is an exploded view showing the construction of the calf or lower leg movement assembly 29. On the upper end of the assembly, a linear actuator 65 and guide rod 66 are constrained by support plate elements 68 by means of threaded fasteners 41 and 41a. On the lower end of the assembly, linear actuators 65 and 67 and the guide rod 66 are held by support plate elements 64 and threaded fasteners 41 and 41a. Ankle holder 30 is attached through holes in the lower portion of the support plate elements 64 and is retained by a cotter pin 76.

FIG. 8 shows the primary manner of use of the preferred embodiment of the present invention. The patient 80 is attached to the robotic leg movement means through ankle cuffs 30, knee cuffs 28, and thigh pads 26. The patient's weight is supported in part by a harness means 81 (in a well known manner) attached to support means 22 through rope 82 and eyebolts 23. Provision is made through use of a pulley system or other similar implement attached to rope 82 (not shown), in well-known manners, to vary the amount of the patient's weight supported by the device. Adjustment of width of the leg movement means 23 to accommodate various patient physical dimensions is accomplished through controlled motion of linear actuators 32.

FIG. 9 is a side view of the patient's leg attached to the lower limb movement means 23. Adjustment of overall height of the lower limb movement means 23 is accomplished through simultaneous adjustment of linear actuators 59 in such a way as to allow proper contact of the patient's feet with the treadmill 83 (as shown in FIG. 8). Appropriate movement of the linear actuator 65, in conjunction with the guide rod 66, allows adjustment of the distance between support plates 64 and 68, thereby adjusting the lower limb movement means 23 to fit the patient's calf. Similarly, activation of the linear actuator 50 in combination with the guide rod 51 allows adjustment of the lower limb movement means 23 to correspond to the patient's upper leg length. In a like manner, the linear actuator 55, in conjunction with the guide rod 54, provides adjustment for the precise contact point of the hip holder 26. Walking motion of the patient, 80, is attained through motion of linear actuators 67, 49, and 56. Linear actuators 65, 50, 55, and 59 are held stationary during walking motion, being used only for adjustment. Movement of the patient's calf is controlled by movement of the linear actuator 67, which causes the ankle cuff 30, the support plates 64, the guide rod 66, and the support plates 68 to rotate as a unit about the bearing 75, thereby raising or lowering the calf. In a similar manner, motion of the patient's thigh is brought about by motion of the linear actuator 49, which causes the knee holder 28, the support plates 47 and 48, the linear actuator 50, and the guide rod 51 to rotate as a unit about the bearing 74, thereby raising or lowering the patient's thigh (and calf if the linear actuator 67 is stationary). Motion of the patient's hip is carried out through motion of the linear actuator 56. Such motion causes the guide rod 54, the support plates 57 and 52, the hip holder 26, and the linear actuator 55 to rotate as a unit about the bearing 73, thereby moving the patient's hip in a motion describing an arc. Coordination of the walking motion of the patient 80 is to be carried out by a computer control system. Such control system forms no part of the present invention.

The present invention is, of course, in no way restricted to the specific disclosure of the specification and drawings, but also encompasses any modifications within the scope of the appended claims.

1. A gait training apparatus comprising:
a frame, and
two robotic limb movement assemblies that are connected to said frame, wherein each of said limb movement assemblies is adapted to receive a leg of a patient, and wherein each limb movement assembly comprises a plurality of sections, each of which is provided with means to move that portion of a patient's leg that is received therein.

2. A gait training apparatus according to claim 1, wherein each limb movement assembly comprises two sections, namely a thigh movement assembly and a calf movement assembly.

3. A gait training apparatus according to claim 2, wherein said thigh movement and calf movement assemblies are each provided with actuating means to effect movement of that portion of a patient's leg that is received therein.

4. A gait training apparatus according to claim 3, wherein said actuating means are linear actuators that are computer controlled.

5. A gait training apparatus according to claim 4, wherein two of said linear actuators are provided for each of said thigh movement and calf movement assemblies, wherein each linear actuator is a piston/cylinder type unit.

6. A gait training apparatus according to claim 3, wherein each of said thigh movement and calf movement assemblies is furthermore provided with an adjustable guide rod.

7. A gait training apparatus according to claim 6, wherein each of said guide rods is a telescoping guide rod.

8. A gait training apparatus according to claim 1, wherein each of said limb movement assemblies is furthermore provided with means for attaching such assembly to at least one of a patient's ankle, knee area, and hip area.

9. A gait training apparatus according to claim 2, wherein each limb movement assembly furthermore comprises a thid section, namely a hip movement assembly.

10. A gait training apparatus according to claim 1, wherein each of said sections of said limb movement assemblies are operatively interconnected and are controlled in an interrelated manner.
